(19) United States
(12) Patent Application Publication
(10) Pub. No.: US 2002/0095812 A1
(43) Pub. Date: Jul. 25, 2002

(54) Leveling and marking tool

(76) Inventor: Gregory T. Newman, Greenville, KY (US)

Correspondence Address: GARY K. PRICE, 111 S.E. THIRD STREET, SUITE 201, EVANSVILLE, IN, 47708-1431, US

(21) Appl. No.: 10/029,650

(22) Filed: Dec. 20, 2001

Related U.S. Application Data
(60) Provisional application No. 60/263,634, filed on Jan. 23, 2001.

(51) Int. Cl. G01D 21/00

(52) U.S. Cl. 33/613

(57) ABSTRACT

A leveling and marking tool for accurately marking a pair of points on a horizontal or vertical line on a work surface or building wall that are exact to match the precut holes found on many items mounted, comprising an elongated rectangular bar, a longitudinally extending guide track, a first and second cone shaped point, and at least one bubble gauge.

### CROSS REFERENCES TO RELATED APPLICATIONS

U.S. Provisional Application for Patent 60/263,634, filed Jan. 23, 2001, with title “Leveling and Marking Tool” which is hereby incorporated by reference. Applicant claims priority pursuant to 35 USC ¶ 119(e)(i).

### STATEMENT AS TO RIGHTS TO INVENTIONS MADE UNDER FEDERALLY SPONSORED RESEARCH AND DEVELOPMENT

Not applicable

### BACKGROUND OF THE INVENTION

1. Field of the Invention

This invention relates to a leveling and marking tool used for mounting items, such as hanging phones, intercoms, smoke detectors, or speakers, that have precut mounting holes, to a work surface or a building wall. The present tool is usable for, but not restricted to, making two indentions on the work surface or building wall that are accurate in either horizontal or vertical relationship with one another to match the precut holes found on the back of the item to be mounted.

Once the indentions are formed in the work surface or building wall, screws or nails, etc., are installed into the work surface or wall at the location of the indentions for mounting the said subject item.

2. Background Information

When hanging phones, intercoms, smoke detectors, speakers, and other items with precut holes, to a work surface, it is essential to insure that the placement of the screws on the wall that the item is to be mounted on are exact. To do this, it is necessary to set out points on the work surface or building wall which match in space and distance with the precut holes found in the back of the item to be mounted. Accurate matching of the manual markings on the work surface or building wall with the precut holes found on the back of the item to be mounted is often difficult and cannot readily be accomplished by simply measuring relevant distances between the precut holes of the item to be mounted. An additional difficulty is that measurements of the distances in question must be measured simultaneously with the fixing of a common vertical or horizontal line. As a result, the prior art method of mounting items having precut holes to a work surface or building wall generally requires carpentry skills.

As will be seen from the subsequent description, the preferred embodiment of the present invention overcome these and other shortcomings of prior art, and provides a simple tool to mark the exact spots where the screws or nails, etc., should be inserted on the wall or work surface to match the precut holes found on the back of the item to be mounted.

### SUMMARY OF THE INVENTION

The present invention is a tool that is a leveling and marking tool including an elongated rectangular bar, said bar further comprising a longitudinally extended opening, a first and second projected tab, a locking means for fixing the second projected tab at a selected location in the opening, and at least one bubble gauge which is parallel to and/or perpendicular to the opening.

The present invention will be more fully understood upon reading the following detailed description of the preferred embodiments in conjunction with the accompanying drawings.

### BRIEF DESCRIPTION OF THE DRAWINGS

FIGS. 1 is a perspective front view of a preferred embodiment of the present invention, a leveling and marking tool.

FIG. 2 is a perspective rear view of the tool of FIG. 1.

FIG. 3 illustrates a perspective view of the tool of FIG. 1 being aligned with an item having two precut holes.

### DESCRIPTION OF THE PREFERRED EMBODIMENTS

FIGS. 1-3 illustrate the preferred embodiment of the present invention, a tool that is a leveling and marking tool 1, comprising an elongated rectangular frame 10, said rectangular frame 10 having a front surface 2, a back surface 3, a longitudinally extending opening 6 which penetrates through the rectangular frame 10, a first projected tab 4 at the end of the rectangular frame 10, a second projected tab 5, a first bubble gauge 8 aligned parallel to the opening 6, and a second bubble gauge 9 aligned perpendicular to the opening 6 and disposed at the opposite end of the rectangular frame 10 to the first projected tab 4. As shown in the drawing figures, the longitudinally extending opening 6 which penetrates through the rectangular frame 10, extends substantially across the length of the rectangular bar 10.

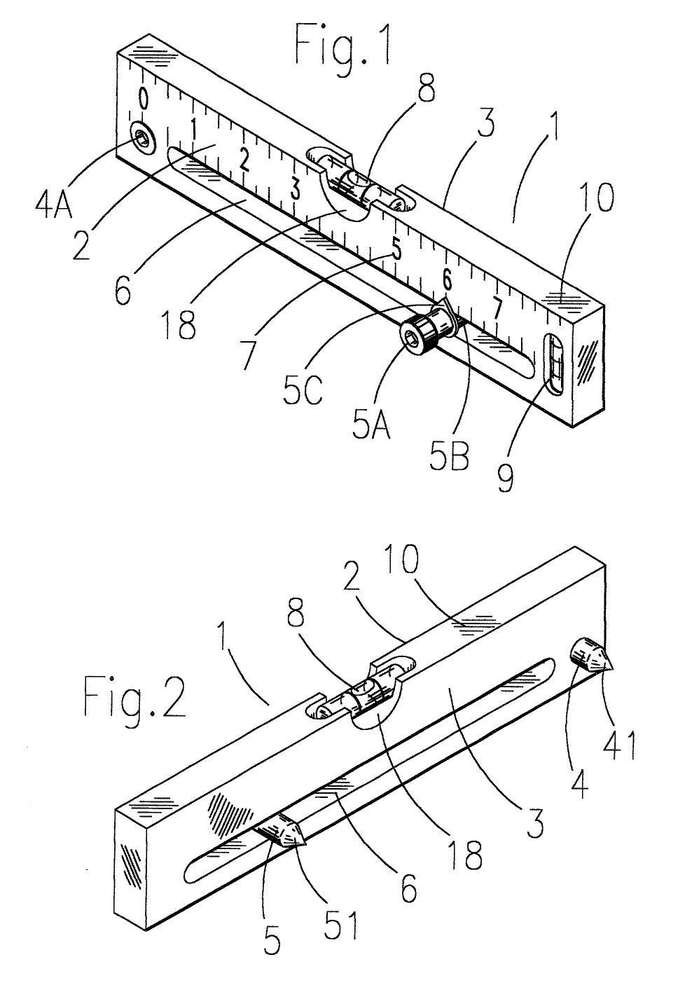

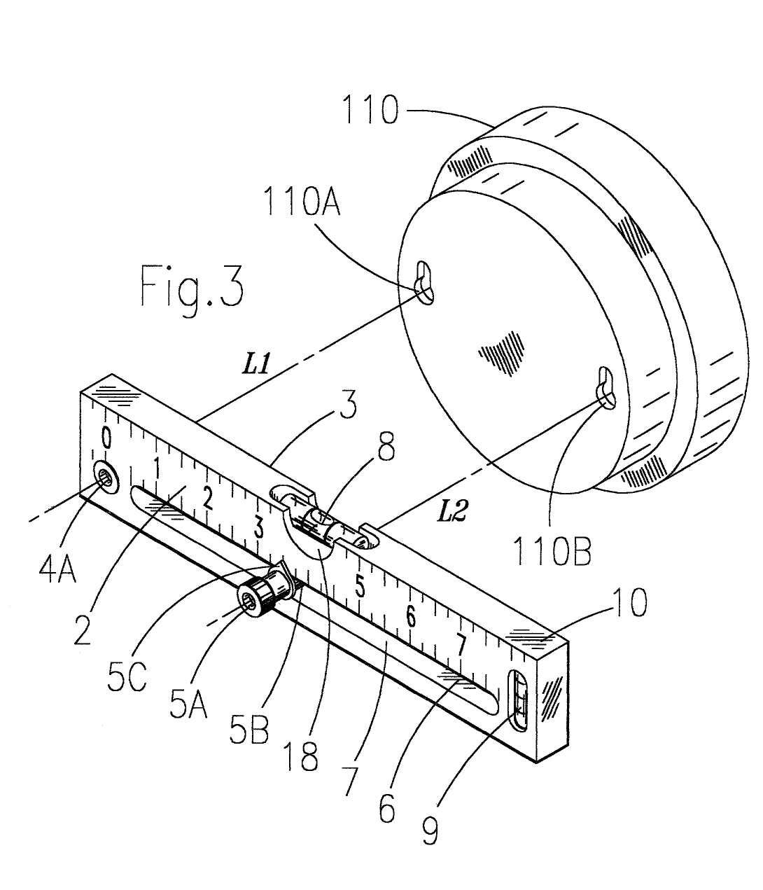

The first projected tab 4 penetrates through the rectangular frame 10, and includes a threaded portion (not shown) that receives a lock screw 4A on one end, and as shown in FIG. 2, includes a conical portion 41 on the opposite end. The second projected tab 5 having a threaded portion (not shown) that receives a lock nut 5A on one end, and a cone portion 51 on the opposite end. The second projected tab 5 further includes a pointer 5C and a flat-machined portion 5B between the said threaded portion and the conical portion 51. In the preferred embodiment, the conical portions 41 and 51 of the first and second projected tabs 4 and 5 are 45 degree coned shape points.

As shown in FIG. 1 and 2, the first projected tab 4 extends through the rectangular frame 10, and is threadably fixed in position using the lock screw 4A. As best shown in FIGS. 1, and 3, the lock screw 4A is disposed on the front surface 2 of the rectangular frame 10 and is located on the same axis as the opening 6. As will be further described, the second projected tab 5 is movably secured within the opening 6, using the lock nut 5A for threadably fixing the second projected tab 5 at selected locations along the axis of the opening 6. As shown in FIGS. 1 and 3, the lock nut 5A is disposed on the front surface 2 of the rectangular frame 10. As shown in FIG. 2, the conical portions 41 and 51 of the first and second projected tabs 4 and 5, outwardly project from the back surface 3 of the rectangular frame 10. Further, the conical portions 41 and 51 of the first and second projected tabs 4 and 5 outwardly project an equal distance from the back surface 3 of the rectangular frame 10 and are on the same axis as the opening 6.

On the front surface 2 of the rectangular frame 10 is displayed a measuring scale 7, said scale 7 displaying units of measure in inches. As shown in FIG. 1, the lock screw 4A of the first projected tab 4 is disposed just below the zero mark of the measuring scale 7 so that the display of the zero position is positioned higher than the lock screw 4A. Said scale 7 is engraved or applied by screen process printing or an analogous procedure on the front surface 2 of the rectangular frame 10.

As shown in FIGS. 1 and 3, the rectangular frame 10 includes a recess portion 18, in which the first bubble gauge 8 can be mounted. The recess portion 18 is disposed at the approximate midway of the top of the rectangular frame 10 adjacent the opening 3 in parallel therewith, the second bubble gauge 9 mounted in the front surface 2 of the rectangular frame 10 adjacent to one end of the opening 3, in perpendicular relation thereto.

Referring to FIG. 3, to mount an item 110 to a work surface or building wall (not shown), said item 110 having a first precut hole 110A and a second precut hole 110B, the user places the conical portion 41 of the first projected tab 4 into the first precut hole 110A of the item 100 that is to be mounted, as indicated by line “L1” in FIG. 3. The user then threadably loosens the lock nut 5A from the second projected tab 5 so that the flat-machine portion 5B of the second projected tab 5 slidably moves in an axial direction along the opening 6. The second projected tab 5 is positioned so that the conical portion 51 is inserted in the second precut hole 110B, as indicated by the line “L2” in FIG. 3, while the conical portion 41 of the first projected tab 4 remains in the first precut hole 110A of the item 110 to be mounted. Once the cone portion 51 of the second projected tab 5 is inserted in the said second precut hole 110B, the second projected tab 5 is then locked in that selected location by threadably tightening the lock nut 5A on the threaded portion of the second projected tab 5. Once the lock nut 5A is tightened to the second projected tab 5 as discussed above, the pointer 5C on the second projected tab 5 is pointing to the displayed unit of measure on the front surface 2 of the rectangular frame 10 that equals the distance between the first precut hole 110A and the second precut hole 110B of the item 110 to be mounted.

The user then places back surface 3 of the rectangular frame 10 against the work surface or building wall that the mounting screws or nails, etc., are going to be installed, with the conical portions 41 and 51 of the first and second projected tabs 4 and 5 in slight contact with the work surface or building wall. Using the bubble gauge 8 or 9, the user then positions the rectangular frame 10 against the work surface or wall until the selected bubble gauge indicates a level position. It is understood to use the first bubble gauge 8 for setting indentions horizontal one beside the other, and using the second bubble gauge 9 for setting indentions vertically one above another.

Once level, the user firmly presses the rectangular frame 10 against the work surface or exterior surface of the building wall. The impact of pressing the rectangular frame 10 against the work surface or exterior surface will cause the conical portions 41 and 51 of the first and second projected tabs 4 and 5 to each make an indention in the work surface or building wall in spaced apart relationship to match the precut holes 110A and 110B on the item 110 to be mounted.

Once the said indentions are formed in the work surface or building walls, the item 110 is set aside and screws or nails (not shown) are installed into the work surface or wall at the location of the indentions for mounting the said item 110. The indentions match the precut holes 110A and 110B on the item 110 to be mounted. Such indentions are on a level plane and are exact in distance apart as the precut holes 110A and 110B found on the item 110 to be mounted. Consequently, the two installed screws or nails are in perfect spaced apart relationship and alignment as the precut holes 110A and 110B on the item to be mounted.

Although the description above contains some specificities, these should not be construed as limiting the scope of the invention but as merely providing illustrations of some of the presently preferred embodiments of this invention. For example, while the examples given relate to the mounting of wall plates for specific items having precut holes as discussed, this invention may be useful for hanging pictures or shelves, or various other carpentry work.

Thus the scope of the invention should be determined by the appended claims in the formal application and their legal equivalence, rather than by the examples given.

I claim:

1. A leveling and marking tool for mounting items having precut mounting holes to a wall, and for making indenting marks in the wall that are in spaced apart relationship to match the precut mounting holes of the item to be mounted, the leveling and marking tool comprising:
a frame having a front surface, a back surface, a lengthwise opening, a first projected tab mounted at an end of the frame on the same axis as the lengthwise opening, a second projected tab movable in an axial direction along the lengthwise opening, threadable locking means for fixing the second projected tab in selected locations along the lengthwise opening spaced longitudinally from the first projected tab at a distance corresponding to the distance between the precut mounting holes, the first and second projected tabs each having a conical point that outwardly projects from the back surface of the frame, at least one bubble gauge mounted to the frame, and means associated with the first projected tab and the second projected tab for accurately indenting said marks in the wall.

2. The tool as recited in claim 1, wherein the conical point of the first projected tab and the conical point of the second projected tab outwardly project an equal distance from the back surface of the frame.

3. The tool as recited in claim 1, wherein the means for indenting the marks in the wall is performed by placing the back surface of the frame against the wall with the conical points of the first projected tab and the second projected tab in slight contact with the wall, aligning the frame against the wall, and firmly pressing the frame against the wall so that the said conical points firmly impact the wall.

4. The tool as recited in claim 2, wherein the conical point of the first projected tab and the conical point of the second projected tab are 45 degree coned shaped points.

5. A leveling and marking tool for mounting an item having precut mounting holes to a wall, and for making marks on the wall that are in spaced apart relationship to match the precut holes of the item to be mounted, the tool comprising:
a frame having an axis, a first projected tab mounted at an end of the frame on the axis, a second projected tab moveable in an axial direction along the frame, locking means for fixing the second tab in selected locations along the frame spaced from the first projected tab at a distance corresponding to a distance between the precut mounting holes, a leveling gauge on said frame and means associated with the first and second projected tabs for making said marks in a spaced and level relationship on said wall such that the mounting holes for said item can be installed at said marks.

6. The marking and leveling tool as recited in claim 5, wherein the first and second projected tabs each include a conical point such that said marks are indented into the wall by applying pressure.

7. The marking and leveling tool as recited in claim 5, wherein the leveling gauge is a bubble gauge mounted in the frame of the tool.

8. The marking and leveling tool as recited in claim 5, wherein the locking means includes threads and passes through a longitudinal slot in the frame.
